(19) United States
(12) Patent Application Publication
(10) Pub. No.: US 2010/0188578 A1
(43) Pub. Date: Jul. 29, 2010

(54) Real Time Information Display Module and Method Thereof

(75) Inventors: Chih-Hao Liang, Taipei (TW); Li-Hsiang Liao, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTEK COMPUTER INC., Peitou (TW)

(21) Appl. No.: 12/689,275

(22) Filed: Jan. 19, 2010

(30) Foreign Application Priority Data
Jan. 23, 2009 (TW) 98102947

(51) Int. Cl. H04N 5/445; H04H 60/33

(52) U.S. Cl. 348/563; 725/14; 348/E05.099

(57) ABSTRACT

A real time information display module and a method thereof are described. The real time information display module is coupled with a display device used for displaying TV signal. The real time information display module includes an information collection unit and an event detection unit. The information collection unit receives a setting instruction of an information category and collects share information corresponding to the information category according to a setting instruction. The event detecting module detects a TV event and an information event corresponding to the TV signal and the share information, respectively. When the TV event and information event exist at the same time, the real time information display module transmits a notification instruction to the display device. As a result, the display device retrieves and outputs the share information from the information collection module.

### CROSS-REFERENCES TO RELATED APPLICATIONS

This non-provisional application claims priority under 35 U.S.C. §119(a) on Patent Application No. 98102947 filed in Taiwan, R.O.C. on Jan. 23, 2009 the entire contents of which are hereby incorporated by reference.

### BACKGROUND OF THE INVENTION

1. Field of the Invention

The invention relates to a display module and a display method and, more particularly, to a real time information display module and a real time information displaying method.

2. Description of the Related Art

With technological advances, a computer gradually becomes one of necessary electronic products for everybody. Furthermore, since the Internet is popular, a user can freely browse the Internet via the computer to obtain a great deal of data and expand the function of a computer system at the same time.

Additionally, as the function of the computer system is gradually expanded, the computer system gradually has the function of traditional household electrical appliances. For example, conventionally, if the user wants to watch a television (TV) program, he needs a TV set to receive a wired or wireless TV signal. Then, the TV signal is provided for the user to watch via the TV set. However, along with the improvement of the function of the computer system, the user can watch the TV program via the computer system. A graphics card of the computer system may be designed with the function of receiving the TV signal. Consequently, the user only needs to connect a cable for transmitting the TV signal with a cable jack of the graphics card, and then the TV signal is displayed to allow the user to watch the TV program via player software in the computer system. As a result, besides using many functions such as text editing, Internet surfing, and programming, the user can also watch the TV program at the same electronic product namely the computer.

When the user utilizes the computer to watch the TV program, the computer must be switched at a TV program mode. Therefore, when new information is generated at the computer, and for example, when a new on-line instant message is received, the user cannot immediately know at the time. As a result, some related technology proposes that when the user watches the TV program, if the new information is generated at the computer system, the new information is immediately displayed at the TV program to inform the user. However, conventionally, the above mentioned method is performed by the player software playing the TV program. That is, different kinds of player software are written with related programs to display a real time message, respectively. Therefore, to cooperate with the program of player software A, people developing the graphics card of the computer develops a corresponding graphics card to allow the user to enjoy the function of immediately displaying the new information of the computer, when he watches the TV program. However, if the user uses the same graphics card and player software B to play the TV program, the information may not be displayed immediately due to the program difference or conflict, and vice versa.

Moreover, conventionally, when the user watches the TV program, if the new information is generated at the computer, it is immediately displayed at a screen, or a reminding signal is generated to inform the user of the new information. Then, the user himself determines whether to make the new information displayed on the screen or not. However, when the user watches the TV program, he may miss a wonderful part of the TV program due to the suddenly appeared real time information or the reminding signal, which disturbs the user during watching.

### BRIEF SUMMARY OF THE INVENTION

The invention provides a real time information display module. The real time information display module is coupled with a display device for displaying a TV signal. The real time information display module includes an information collection unit and an event detection unit. The information collection unit receives a setting instruction of an information category and collects sharing information corresponding to the information category according to the setting instruction. The event detection unit detects a TV event and an information event corresponding to the TV signal and the sharing information, respectively. When the TV event and the information event exist at the same time, the real time information display module transmits a notification instruction to the display device to make the display device retrieve and display the sharing information of the information collection unit.

The invention also provides a method of displaying real time information on a display device. The display device displays a TV signal. The method includes the following steps. First, a setting instruction of an information category is received. Second, sharing information corresponding to the information category is collected according to the setting instruction. Third, an information event and a TV event corresponding to the sharing information and the TV signal, respectively, are detected. Fourth, the sharing information is retrieved when the TV event and the information event exist at the same time. Fifth, the sharing information is outputted.

A related event can be automatically detected according to the device or the method of the invention. The event can be set by the user himself or internally set in the system. When the event is generated, the information is displayed at the display module. As a result, the information is displayed at proper time, the quality of the user watching is not affected. Furthermore, the related software is written into an application design interface that most of the computer systems have, which can allow the graphics cards or audio-visual player software of different manufactures to be conveniently used. Therefore, a cost for developing the software is reduced.

These and other features, aspects and advantages of the present invention will become better understood with regard to the following description, appended claims, and accompanying drawings.

### BRIEF DESCRIPTION OF THE DRAWINGS

FIG. 1 is a block diagram showing a real time information display module according to a first embodiment of the invention;

FIG. 2 is a block diagram showing a real time information display module according to a second embodiment of the invention; and

FIG. 3 is a flow chart showing a real time information displaying method.

### DETAILED DESCRIPTION OF THE EMBODIMENTS

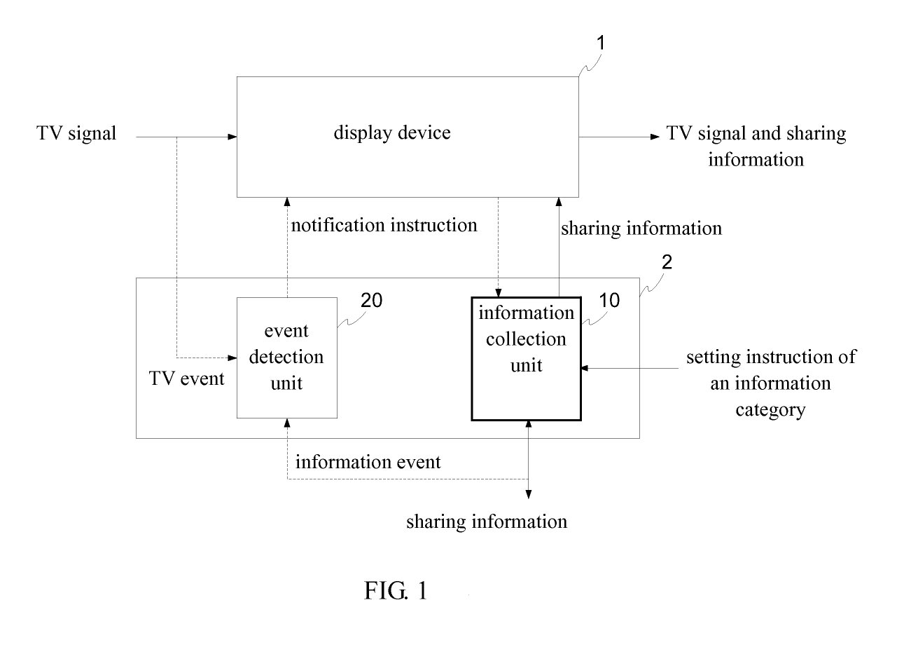

FIG. 1 is a block diagram showing a real time information display module according to a first embodiment of the invention. A real time information display module 2 according to the invention is coupled with a display device 1. The display device 1 is used for displaying a TV signal. The real time information display module 2 includes an information collection unit 10 and an event detection unit 20.

The information collection unit 10 receives a setting instruction of an information category. The setting instruction of the information category may be set according to demands or favor of a user, or it may be internally set before the device leaves the factory. Then, an information collection unit 10 collects sharing information corresponding to information category according to the setting instruction. For example, the information categories set by the setting instruction are data published and issued via the Internet. Then, the information collection unit 10 collects related data in the Internet to be used as the sharing information.

The event detection unit 20 detects a TV event corresponding to the TV signal and an information event corresponding to the sharing information, respectively. When the TV event and the information event exist at the same time, the real time information display module 2 sends a notification instruction to the display device 1. At the same time, the display device 1 informs the information collection unit 10, and it retrieves the sharing information from the information collection unit 10. Finally, the sharing information is outputted by the display device 1, and the outputted sharing information may be mixed with the TV signal to be outputted by the display device 1 to the user.

Arrows shown in FIG. 1 are drawn by real lines and dotted lines. The real lines represent the transmission of signals such as the TV signal, the sharing information, and the information category. The dotted lines represent the transmission of instructions and commands such as the TV event, the information event, and the notification instruction.

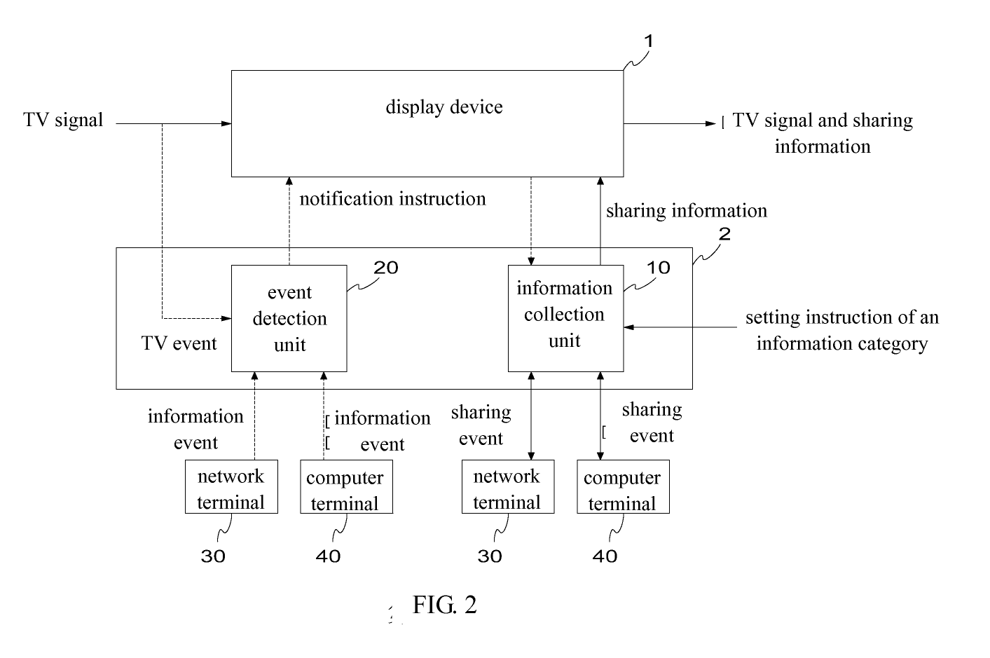

FIG. 2 is a block diagram showing a real time information display module according to a second embodiment of the invention. The sources of the sharing information, the TV event, and the information event are illustrated in the second embodiment. The sharing information may be provided by the network terminal 30. For example, when the user utilizes the computer system to connect with the Internet and utilizes the Internet to browse Internet information and use an on-line multimedia function and so on, if he switches the mode to utilize the computer system to watch a TV program, he may set the sharing information to be the messages of network news and the messages of on-line instant messaging (such as Yahoo messenger, MSN messenger, Skype, or ICQ) or different kinds of information transmitted via network terminal 30 such as a personal audio-visual message (such as YouTube) at the time.

Moreover, the sharing information also may be provided by the computer terminal 40. For example, when the user utilizes the computer system to watch the TV program, if the user wants to know the state of the computer system or a result of executing a specific program at the time, the sharing information may be different kinds of information generated by the computer terminal 40 itself such as an electronic mail (E-mail) mail, a schedule, or a virus scan result at the time.

On the other hand, the events also may be provided by different sources. For example, the information event may be obtained from the network terminal 30 or the computer terminal 40. In this state, the information event may be various events such as updating network data, receiving an on-line instant message, or reminding of the schedule generated by the network terminal 30 or the computer terminal 40.

Additionally, the TV event may be generated according to the TV signal, and the time of generating the TV event may be the time at which the user watching the TV program is not affected. For example, the events may be different kinds of events such as an advertising time, a short interval in switching the TV programs, or bad reception of the TV signal generated from the TV signal. The TV event, the information event, or the sharing information listed above may be set, but not limited to, by the user according to his demands or favor.

The event detection unit 20 may automatically detect the TV event and the information event listed above. When the event detection unit 20 detects that both the TV event and the information event occur, it provides the sharing information collected by the information collection unit 10 to the display device 1, and the display device 1 outputs the TV signal and the sharing information at the same time. As a result, when the user watches the TV program, he can know the sharing information from the network terminal 30 or the computer terminal 40. Furthermore, since the time of displaying the sharing information at the TV program is that of generating the event, the sharing information does not interferes with the TV program enjoyed by the user. Consequently, the watching quality of the user is maintained.

The sharing information and different kinds of events as stated above are illustrated as follows with two situations, respectively. The sharing information is provided by the network terminal 30 in the first situation. A user A has a computer disposed with a graphics card receiving the TV signal. The user A utilizes on-line instant communication software of the computer system to chat with a friend B, and an important ball game is to be broadcasted at the time. The user A switches the computer system to be in the TV matching mode to watch the rebroadcast of the ball game. If the user A sends out the setting instruction received by the information collection unit 10 in advance to set the information category to be the on-line instant message, the information collection unit 10 collects the on-line instant message to be used as the sharing information.

When the user A watches the ball game, if the friend B still transmits the on-line instant message, and the computer system receives the on-line instant message, the information event occurs. When the information event of receiving the on-line instant message occurs, the sharing information (the on-line instant message) at the moment is not immediately displayed at the TV signal, and it is outputted when the TV event occurs. When the ball game is at half-time and advertisement is broadcasted, which represents that the TV event occurs, the TV event and the information event exist at the same time. Therefore, the information collection unit 10 transmits the sharing information collected before to the display device 1 (the screen of the computer) to make the display device 1 output the sharing information in the TV signal at the same time (the TV signal broadcasts the advertisement at this moment). As a result, the user knows that the friend B transmits a new on-line instant message.

The sharing information is provided by the computer terminal 40 in the second situation. The user A has a computer disposed with the graphics card receiving the TV signal. The user

A utilizes related software in the computer to plan the schedule. At the time, an a movie expected by the user A for a long time is to be first broadcasted at a TV channel, and the user A switches the computer system to be in a TV matching mode to watch the movie. If the user A sends out the setting instruction received by the information collection unit 10 in advance to set the information category to be a schedule reminding message, the information collection unit 10 collects the schedule reminding message to be used as the sharing information.

When the user A watches the movie, if the schedule reminding message is generated to remind the user A of schedule data related to a meeting tomorrow, the information event is generated. Similarly, when the information event occurs, the sharing information (that is the schedule reminding message) at the moment is not immediately displayed in the TV signal to prevent the sharing information from interfering with the movie enjoyed by the user A. When the movie breaks for the advertisement, that is, when the TV event occurs, both the TV event and the information event exist at the same time, and then the information collection unit 10 transmits the sharing information collected before to the display device 1 to make the display device 1 output the sharing information in the TV signal at the same time. As a result, the user knows the related schedule data about the meeting tomorrow via the schedule reminding message.

As stated above, the information collection unit 10 and the event detection unit 20 according to the invention may be disposed at the graphics card of the computer system. Additionally, since a general computer system is installed with a Windows operating system developed by Microsoft. DirectShow is developed by Microsoft, and is an application design interface allowing a software developer to perform various operations with the multimedia files. DirectShow provides the extensible interface for the multimedia files, and thus the user or the developer may utilize the framework of the DirectShow to compile relating programs to render or record the multimedia files. Furthermore, the DirectShow is a filter-based framework, and therefore, the related software corresponding to the device of the invention may be written to the filter. As a result, even if the audio-visual player software is different, it may obtain the related software of the device of the invention via the basic filter-base framework in the DirectShow to smoothly broadcast.

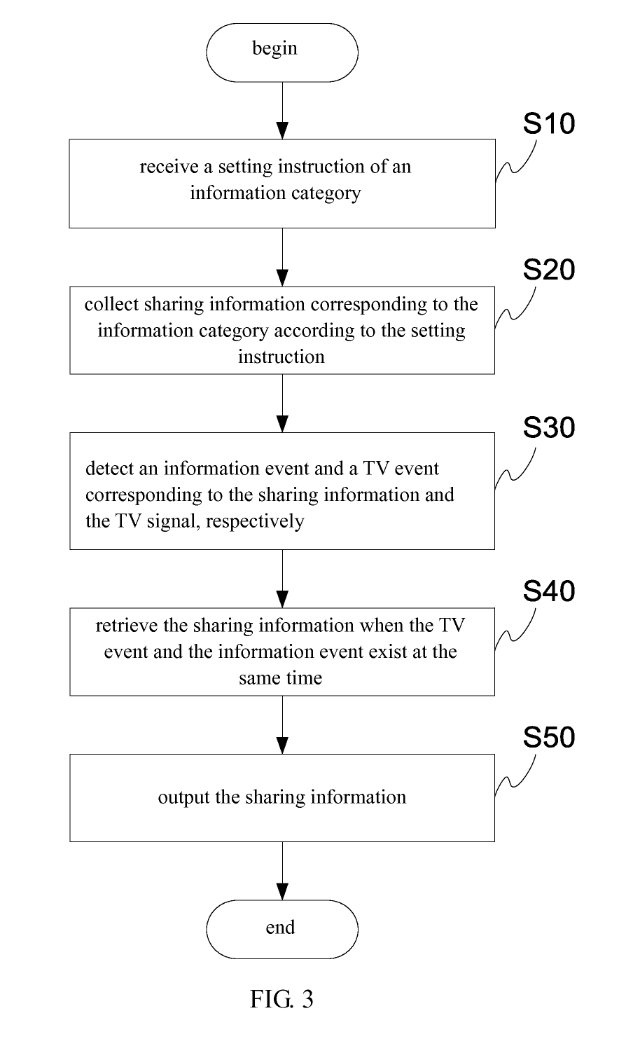

FIG. 3 is a flow chart showing a real time information displaying method. The method may be used for displaying the real time information at the display device. The display device can display the TV signal. The method includes the following steps.

In step S10, the setting instruction of the information category is received.

In step S20, the sharing information corresponding to the information category is collected according to the setting instruction. The sharing information may be provided by the network terminal. At the time, the sharing information may be chosen from one or the combination of a piece of the network news, the on-line instant message, and a piece of on-line personal audio-visual data.

The sharing information also may be provided by the computer terminal. At this time, the sharing information may be chosen from one or the combination of the mail, the schedule, and the virus scan result.

In step S30, the information event and the TV event corresponding to the sharing information and the TV signal, respectively, are detected. The event may be generated by the network terminal or the computer terminal. At the time, the event may be chosen from one or the combination of the event of updating the network data, receiving the on-line instant message, and reminding of the schedule.

The event also may be generated according to the TV signal. At the time, the event may be chosen from one or the combination of the advertising time, the TV program switch, or the bad reception of the TV signal.

In step S40, when the TV event and the information event exist at the same time, the sharing information is retrieved

In step S50, the sharing information is outputted.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A real time information display module, coupled with a display device for displaying a television (TV) signal, the real time information display module comprising:
an information collection unit receiving a setting instruction of an information category and collecting sharing information corresponding to the information category according to the setting instruction; and
an event detection unit detecting a TV event and an information event corresponding to the TV signal and the sharing information, respectively;
wherein, when the TV event and the information event exist at the same time, the real time information display module transmits a notification instruction to the display device to make the display device retrieve and output the sharing information of the information collection unit.

2. The real time information display module according to claim 1, wherein the sharing information is provided by a network terminal.

3. The real time information display module according to claim 2, wherein the sharing information is chosen from one or a combination of a piece of network news, an on-line instant message, and a piece of on-line personal audio-visual data.

4. The real time information display module according to claim 1, wherein the sharing information is provided by a computer terminal.

5. The real time information display module according to claim 4, wherein the sharing information is chosen from one or a combination of a mail, a schedule, and a virus scan result.

6. The real time information display module according to claim 1, wherein the information event is derived from a network terminal or a computer terminal.

7. The real time information display module according to claim 6, wherein the information event is chosen from one or a combination of the event of updating network data, receiving on-line instant message, and reminding of a schedule.

8. The real time information display module according to claim 1, wherein the TV event is generated according to the TV signal.

9. The real time information display module according to claim 8, wherein the TV event is chosen from one or a combination of an advertising time, a TV program switch, and bad reception of the TV signal.

10. A method of displaying real time information on a display device, wherein the display device displays a TV signal, the method of displaying real time information on the display device comprising:
receiving a setting instruction of an information category;
collecting sharing information corresponding to the information category according to the setting instruction;
detecting an information event and a TV event corresponding to the sharing information and the TV signal, respectively;
retrieving the sharing information when the TV event and the information event exist at the same time; and
outputting the sharing information.

11. The method of displaying real time information on the display device according to claim 10, wherein the step of collecting the sharing information corresponding to the information category comprises:
providing the sharing information via a network terminal.

12. The method of displaying real time information on the display device according to claim 11, wherein the sharing information is chosen from one or a combination of a piece of network news, a on-line instant message, and a piece of on-line personal audio-visual data.

13. The method of displaying real time information on the display device according to claim 10, wherein the step of collecting the sharing information corresponding to the information category comprises:
providing the sharing information via a computer terminal.

14. The method of displaying real time information on the display device according to claim 13, wherein the sharing information is chosen from one or a combination of a mail, a schedule, and a virus scan result.

15. The method of displaying real time information on the display device according to claim 10, wherein the step of detecting the information event and the TV event corresponding to the sharing information and the TV signal, respectively, comprises:
generating the information event via a network terminal or a computer terminal.

16. The method of displaying real time information on the display device according to claim 15, wherein the information event is chosen from one or a combination of the event of updating network data, receiving on-line instant message, and reminding of a schedule.

17. The method of displaying real time information on the display device according to claim 10, wherein the step of detecting the information event and the TV event corresponding to the sharing information and the TV signal, respectively, comprises:
generating the TV event according to the TV signal.

18. The method of displaying real time information on the display device according to claim 17, wherein the TV event is chosen from one or a combination of an advertising time, a TV program switch, and bad reception of the TV signal.
